(19) United States
(12) Patent Application Publication
(10) Pub. No.: US 2019/0114693 A1
(43) Pub. Date: Apr. 18, 2019

(54) GROUP SHOPPING RULES ENGINE

(71) Applicant: Walmart Apollo, LLC, Bentonville, AR (US)

(72) Inventors: Jinzhi Zhang, Bentonville, AR (US); Akhileshwar Guli, Bentonville, AR (US); Ankita Kashyap, Bentonville, AR (US); Josh W. Banta, Anderson, MO (US); Charles H. Lobo, Cave Springs, AR (US); Ravindar Milkuri, Bentonville, AR (US); Gnana Bharath C. Nedurumalli, Rogers, AR (US)

(21) Appl. No.: 16/163,899

(22) Filed: Oct. 18, 2018

Related U.S. Application Data
(60) Provisional application No. 62/573,988, filed on Oct. 18, 2017.

(51) Int. Cl. G06Q 30/06; G06F 17/30

(52) U.S. Cl. CPC G06Q 30/0637; G06Q 30/0641; G06F 17/30528

(57) ABSTRACT

Systems, apparatuses, and methods are provided herein for facilitating group retail purchases via electronic user interfaces. A method comprises providing, with a control circuit, a group shopping interface to a plurality of user interface devices, receiving a purchase request from a member of a shopping group, the purchase request comprises a request to purchase one or more products, retrieving product characteristics associated with the one or more products from a product database, retrieving at least one purchase rule from a rules database storing purchase rules for a plurality of shopping groups, wherein the rules database comprises system populated purchase rules generated through a machine learning algorithm based on a group history of the shopping group, and automatically rejecting or automatically approving the purchase request based on the at least one purchase rule and the product characteristics associated with the one or more products.

### CROSS-REFERENCE TO RELATED APPLICATION

This application claims the benefit of the following U.S. Provisional Application No. 62/573,988 filed Oct. 18, 2017, which is incorporated herein by reference in its entirety.

### TECHNICAL FIELD

This invention relates generally to rule engines.

### BACKGROUND

Brick and mortar stores typically display a number of products for sale. A customer can browse and select items in the store and approach a checkout counter to purchase the selected items.

### BRIEF DESCRIPTION OF THE DRAWINGS

Disclosed herein are embodiments of apparatuses and methods for facilitating group retail purchases via electronic user interfaces. This description includes drawings, wherein:

FIG. 1 comprises a system diagram in accordance with several embodiments;

FIG. 2 comprises a flow diagram in accordance with several embodiments;

FIG. 3 comprises a flow diagram in accordance with several embodiments;

FIG. 4 comprises a flow diagram in accordance with various embodiments of these teachings; and

FIG. 5 comprises a data flow diagram in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for facilitating group retail purchases via electronic user interfaces. In one embodiment, a system for facilitating group retail purchases via electronic user interfaces comprises a network interface configured to communicate with a plurality of user interface devices, a product database storing characteristics of a plurality of products offered for sale, a rules database storing purchase rules for a plurality of shopping groups, and a control circuit coupled to the network interface, the product database, and the rules database. The control circuit being configured to provide a group shopping interface to the plurality of user interface devices via the network interface, the group shopping interface being configured to facilitate group purchase decisions in shopping groups, receive a purchase request from a member of a shopping group, the purchase request comprises a request to purchase one or more products, retrieve product characteristics associated with the one or more products from the product database, retrieve at least one purchase rule from the rules database, wherein the rules database comprises system populated purchase rules generated through a machine learning algorithm based on a group history of the shopping group, and automatically reject or automatically approve the purchase request based on the at least one purchase rule and the product characteristics associated with the one or more products.

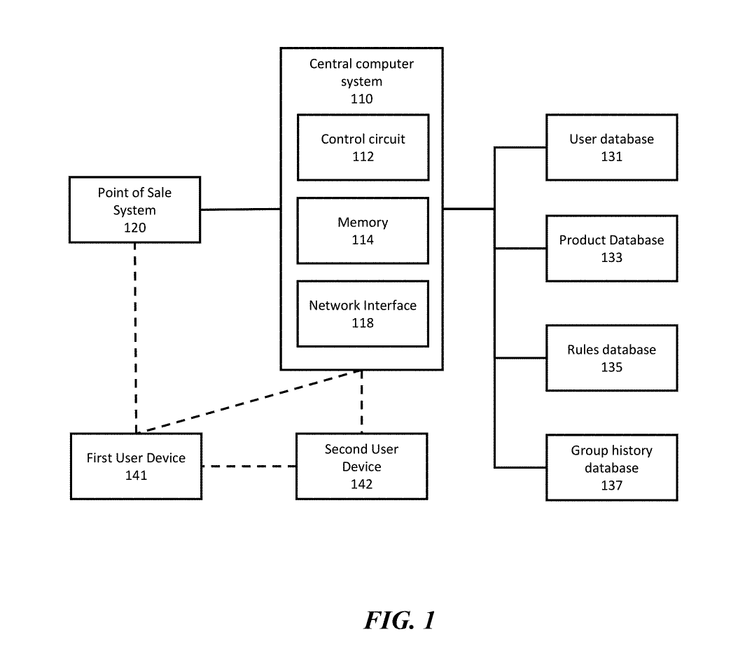

Referring now to FIG. 1, a group shopping system is shown. The system comprises a central computer system 110, a user database 131, a product database 133, a rules database 135, a group history database 137, a point of sale (POS) system 120, a first user device 141, and a second user device 142.

The central computer system 110 comprises a control circuit 112, a memory 114, and a network interface device 118. The control circuit 112 may comprise a processor, a microprocessor, a microcontroller, and the like and is configured to execute computer readable instructions stored in a computer-readable storage memory 114. The computer-readable storage memory 114 may comprise volatile and/or non-volatile memory and have stored upon it a set of computer readable instructions which, when executed by the control circuit 112, causes the control circuit 112 to enforce and populate purchase rules for shopping groups through a group shopping user interface provided to the first user device 141 and the second user device 142 via the network interface device 118. In some embodiments, the group shopping user interface may comprise a graphical user interface (GUI) provided via a network connection such as the internet. In some embodiments, the control circuit 112 may be configured to generate or modify purchase rules in the rules database 135 based on information stored in the group history database 137. In some embodiments, the control circuit 122 may be configured to determine whether an item may be purchased using the group's payment source based on the information stored in the user database 131, product database 133, rules database 135, and/or user input.

In some embodiments, a group shopping interface is configured to facilitate group purchase decisions in shopping groups. In some embodiments, a shopping group may comprise a user group that shares a virtual shopping basket. In some embodiments, group purchases may require approval from one or more designated members of a group. In some embodiments, a shopping group may share a common payment account/method for purchases. In some embodiments, groups may comprise primary members whose item purchase/selections do not require approval and secondary members whose purchase/selections requires approval from the primary members. For example, a shopping group may comprise a family of parents as primary members and children as secondary members. When a child wants to add an item to the group's purchase, approval may be required. In another example, a supervisor may be a primary member of an office shopping group. In some embodiments, item purchases are approved through polling the group members (e.g. consensus, majority, etc.)

In some embodiments, the central computer system 110 may further implement one or more of a rules engine, a payment engine, a logistics engine, and a recommendation for the group shopping user interface. In some embodiments, the rules engine enforces purchase rules in the rules database 135 for shopping groups. In some embodiments, the rules engine further populates rules in the rules database 135 based on group history. In some embodiments, the payment engine may be configured to select payment methods and process payments for group purchases. In some embodiments, the logistics engine may be configured to recommend purchase methods and locations and schedule product pickup and deliveries for customers and the retailer. In some embodiments, the recommendation engine may be configured to recommend products for the group to purchase based on the group's and/or individuals' purchase history. In some embodiments, the recommendation engine may further be configured to recommend alternative products in response to rejected purchase requests based on the group's purchase rules.

The user database 131 may store user and/or group profile data for a plurality of users of a group shopping user interface. In some embodiments, the user database 131 may store information such as user name, user location, user preference, user log-in credential, user social connections, user purchase history, etc. In some embodiments, the central computer system 110 may use the information stored in the user database 131 to determine user relations and characteristics for rule enforcement and/or rule creation. For example, age restricted products may not be purchased by a minor. In some embodiments, the central computer system 110 may use the information stored in the user database 131 to authenticate users seeking to participate in the group shopping user interface. In some embodiments, the central computer system 110 may use the information stored in the user database 131 to configure the group shopping user interface and/or products presented to the user in the user interface. For example, products displayed to a user may be selected and arranged based on their individual or group shopping habits, preferences, demographic, etc. In some embodiments, the user database 131 may further store group association of the users and group profiles for shopping groups. In some embodiments, group profiles may specify roles of one or more members of the group. For example, group members may be organized into a hierarchy in which purchases by users lower in the hierarchy requires approval from one or more members of the higher hierarchy. In some embodiments, one or more shopping groups may comprise at least one secondary member whose purchases through the group shopping interface requires approvals from one or more primary members of the shopping group. In some embodiments, the groups may be organized to make purchases based on group consensus. For example, the group may require the majority of group members to agree on a purchase before allowing the purchase to be paid for by the group payment method.

The product database 133 may store product information data associated with a plurality of products offered for sale via the group shopping user interface, online stores, and/or brick and mortar stores. In some embodiments, product information data may comprise one or more of product price, product category, product description, age restriction, product nutrition information, product material, product ingredient, etc. In some embodiments, the product database 133 may further store product availability information at one or more store locations.

The rules database 135 may store purchase rule data for a plurality of shopping groups. In some embodiments, purchase rules may comprise rules specifying the conditions under which items may or may not be added to a group shopping cart and/or purchased by a shopping group. In some embodiments, purchase rules in the rules database comprise one or more of maximum per-item price restriction, maximum per-period spending restriction, product unit limit, age restriction, product category restriction, product nutrition restriction, product material restriction, and product ingredient restriction. In some embodiments, the rules database comprises system-populated purchase rules generated through a machine learning algorithm based on a group history of the shopping group stored in the group history database 137. In some embodiments, the rules database may comprise user-configured purchase rules inputted by one or more members of the shopping group through the group shopping interface. In some embodiments, a machine learning algorithm may be configured to generate one or more system populated purchase rules based on existing user configured purchase rules.

The group history database 137 may store group histories associated with a plurality of shopping groups. In some embodiments, group histories may comprise past rejections and approvals of purchase requests and/or past group purchases. In some embodiments, group histories may comprise past user overrides of one or more system populated purchase rules. In some embodiments, group histories may comprise recent purchases and/or spending of the group for the enforcement of spending limit rules. In some embodiments, the group history database 137 may further store past purchase information on individual members of the groups. Generally, group histories may be used by the central computer system 110 to configure new rules or modify existing rules in the rules database 135. In some embodiments, group histories of multiple shopping groups may be aggregated to generate rules for a specific group. For example, the system may adopt rules from similar groups to a specific group.

While the user database 131, the product database 133, the rules database 135, and the group history database 137 are shown to be outside of the central computer system 110, in some embodiments, the user database 131, the product database 133, the rules database 135, and/or the group history database 137 may be implemented on the memory 114 and/or one or more other computer-readable memory storage devices coupled to the control circuit 112 of the central computer system 110. In some embodiments, the user database 131, the product database 133, the rules database 135, and/or the group history database 137 may be accessed by the central computer system 110 via a wired or wireless data connection and/or via a network.

The POS system 120 comprises one or more devices configured to receive customer payment and/or process sales. In some embodiments, the POS system 120 may comprise staffed or self-checkout terminals in a brick and mortar store or an online store ordering system. In some embodiments, the POS system 120 may comprise an item scanner comprising one or more of a barcode scanner, a Radio Frequency Identification (RFID) scanner, an optical reader, a scale, a keypad, etc. In some embodiments, the POS system 120 may comprise a payment acceptor configured to receive one or more forms of payment methods such as a Near Field Communication (NFC) reader, a barcode scanner, an optical reader, a card reader, a cash receptor, a keypad, an IC chip reader, etc. In some embodiments, the POS system 120 may comprise a virtual checkout terminal provided via a user interface for the user to enter/select payment information via a user interface device such as the first user device 141 and the second user device 142. In some embodiments, the POS system 120 may comprise software modules within the group shopping user interface provided by the central computer system 110. In some embodiments, the POS system 120 may be implemented via one or more of the central computer system 110, the first user device 141, and the second user device 142. In some embodiments, the POS system 120 may be configured to communicate with the central computer system 110 via a wired or wireless data connection and/or via a network. In some embodiments, the POS system 120 may be integrated with the central computer system 110 and share one or more hardware and software components.

The first user device 141 and the second user device 142 may generally comprise processor-based user interface devices. In some embodiments, the first user device 141 and the second user device 142 may each comprise a processor, a memory device, and one or more user input/output devices. In some embodiments, user input/output devices may comprise one or more of a display screen, a touch screen, a VR display, an AR display, one or more buttons, a keypad, a microphone, a speaker, a camera, a motion sensor, an eye movement sensor, etc. In some embodiments, the first user device 141 and the second user device 142 may comprise one or more of a smartphone, a mobile device, a head-mounted display, a virtual reality (VR) display device, an augmented reality (AR) display device, a wearable device, a tablet computer, a laptop computer, a desktop computer, an internet of things (IOT) device, etc.

In some embodiments, the user devices may be configured to display a group shopping user interface to a user. In some embodiments, the group shopping user interface may comprise one or more of a software program, a mobile application, a cloud-based application, a web page, a web browser extension, and the like. In some embodiments, the group shopping user interface may display product information provided via the central computer system 110 comprising one or more of a product image, a 3D model, a product description, a product price, product options, and a link to a product webpage. In some embodiments, the group shopping user interface may allow users to capture an image of a product using mobile device camera to identify the product to add to a group shopping basket. In some embodiments, the system may determine whether the user is authorized to purchase the item using the group's payment account. In some embodiments, the system may determine whether the system may automatically approve or decline a purchase request based on rules in the rules database 135 and provide the result of the determination to the user via the group shopping user interface. In some embodiments, the system may determine that a purchase requires authorization from one or more other members of the group and send the purchase request to the group members for review. In some embodiments, the system may determine that a group vote is needed to purchase the item and generate an electronic poll for the members of the group to vote on the item.

While only two user devices are shown in FIG. 1, the central computer system 110 may simultaneously communicate with a plurality of user devices associated with a plurality of customers to provide group shopping experiences over a network such as the Internet. In some embodiments, three or more users may participate in a single group shopping session. For example, three or four users may collectively select and approve items for purchase via the group shopping user interface. In some embodiments, the system may allow a user to participate in a plurality of group shopping sessions with different groups of people at the same time.

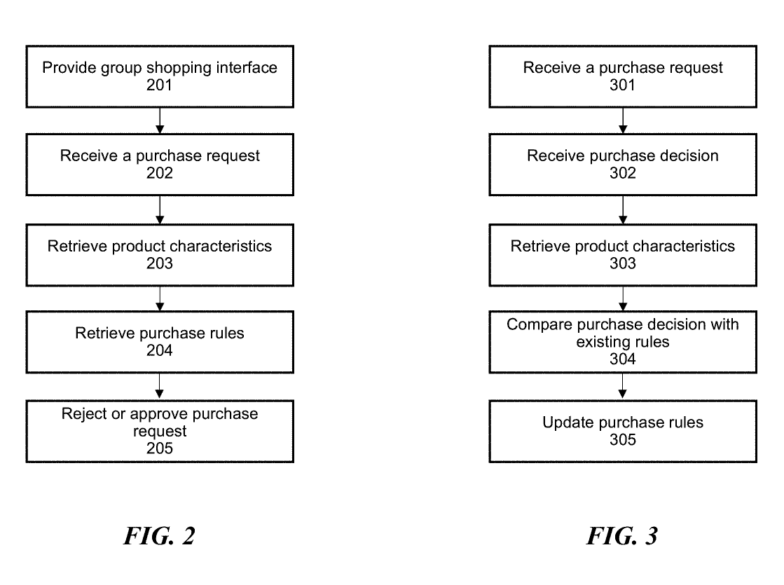

Referring now to FIG. 2, a method for facilitating group retail purchases via electronic user interfaces is shown. In some embodiments, the steps shown in FIG. 2 may be performed by a processor-based device such as one or more of a central computer system, a server, a user device, and a point of sale system. In some embodiments, the steps in FIG. 2 may be performed by one or more of the central computer system 110, the POS system 120, the first user device 141, and the second user device 142 described with reference to FIG. 1 herein or similar devices.

In step 201, the system provides a group shopping user interface to a plurality of user interface devices. The group shopping interface may be configured to facilitate group purchase decisions in shopping groups. In some embodiments, the group shopping user interface may comprise one or more of a software program, a mobile application, a cloud-based application, a VR device application, an AR device application, a web page, a web browser extension, and the like. In some embodiments, users may initiate and/or join group shopping sessions in the group shopping user interface. For example, a customer may configure a group's shopping payment method and user roles using the group shopping interface. In some embodiments, groups may be configured to be a hierarchical group, wherein one or more select member can set the purchase rules and can approve or reject items selected by other members of the group. In some embodiments, a group may comprise primary members and secondary members where items selected by secondary members requires approvals from one or more primary members of the shopping group. In some embodiments, a group may comprise a voting group in which purchases decisions are made by consensus of the group. In some embodiments, a group may comprise a family, a social group, a workplace, and the like. In some embodiments, the group may share a common payment method/payment account (e.g. credit card, debit card, gift card, bank account, cryptocurrency account, store credit account etc.). In some embodiments, the group may be associated with a store credit or gift card account funded by one or more members of the group. In some embodiments, group purchases refer to purchases paid for by the payment account associated with the group.

In step 202, the system receives a purchase request from a member of a shopping group. In some embodiments, a user may set a purchase request by selecting an item to add to a group virtual shopping basket/shopping list. A purchase request generally refers to a request to purchase one or more items with the group's payment account. In some embodiments, the user may select an item from an online shopping user interface to add to a group basket/shopping list. In some embodiments, the user may capture an image (e.g. barcode, label, packaging, etc.) of the item to add an in-store item to the group basket/shopping list. In some embodiments, the system may determine whether the user requires authorization to make group purchases and proceed to step 203 if manual or automatic authorization is required. For example, a primary member of a group may directly purchase items without sending purchase requests and a secondary member's purchase request would be processed through the steps 203-205 described herein.

In step 203, the system retrieves product characteristics associated with the one or more products in the purchase request from the product database. In some embodiments, product characteristics may comprise one or more of product price, product category, product description, age restriction, product nutrition information, product material, product ingredient, etc. In some embodiments, product characteristics may be retrieved from product database 133 or a similar database.

In step 204, the system retrieves at least one purchase rule from the rules database. The rules database may store purchase rules for a plurality of shopping groups. In some embodiments, the purchase rules may be retrieved from rules database 135 or a similar database. In some embodiments, purchase rules may comprise rules specifying the conditions under which items may or may not be added to a group shopping cart and/or purchased through a shopping group. In some embodiments, the rules database comprises system populated purchase rules generated through a machine learning algorithm based on a group history of the shopping group. In some embodiments, the machine learning algorithm may generate purchase rules for a group based on the group's purchase history and/or purchase decision history. In some embodiments, the rules database may further comprise user configured purchase rules inputted by one or more members of the shopping group through the group shopping interface. In some embodiments, the machine learning algorithm may be configured to generate one or more system-populated purchase rules based on existing user configured purchase rules.

In some embodiments, purchase rules in the rules database may comprise one or more of maximum per-item price restriction, maximum per-period spending restriction, product unit limit, age restriction, product category restriction, product nutrition restriction, product material restriction, and product ingredient restriction. In some embodiments, one or more rules may comprise automatic approval rules or automatic rejection rules. A maximum per-item price restriction rule may, for example, specify that items over $50 will be automatically rejected. In some embodiments, item price may be based on the current store pricing of the store (physical or online store) associated with the purchase request. A maximum per-period spending restriction rule may, for example, specify that any purchase request after the first $300 in a month would be rejected. The per-period spending restriction may be set for each user and/or for the entire group. A product unit limit rule may, for example, specify that only 2 gallons are milk can be purchased in a month. An age restriction rule may, for example, automatically reject age-restricted products such as tobacco, alcohol, R-rate movies, M-rated video games, etc. A product category restriction may, for example, automatically reject or approve products from select product categories (e.g. fresh produce, dairy, cleaning supply, games, toys, etc.). A product nutrition restriction rule may, for example, automatically reject items with high sugar content such as soda and candy. In some embodiments, nutritional information may be obtained from product packaging and stored in the product database. A product material and/or ingredient restriction rule may, for example, automatically approve organic products or reject products with an allergen (e.g. peanuts, dairy).

In some embodiments, a machine learning algorithm may be used to populate purchase rules based on the group history of the shopping group. In some embodiments, the machine learning algorithm may populate new rules based on the group history comprising past rejections and approvals of purchase requests and/or past group purchases. For example, if requests to purchase soda are routinely rejected by the group, the system may populate a new rule to automatically reject future requests to purchase soda. In another example, if requests to purchase products over $50 are always rejected by the group, the system may populate a new rule for automatically rejecting any item over $50. In some embodiments, the machine learning algorithm may modify rules based on past user overrides of one or more system populated purchase rules. For example, if the system previously has a rule that automatically rejects requests to purchase products containing soy but a primary user overrides the rejection several times, the system may refine (e.g. only baby food containing soy) or remove the rule. In some embodiments, the machine learning algorithm may further be configured to generate one or more system populated purchase rules based on existing user configured purchase rules. For example, if the user inputted a rule that restricts the purchase of high sodium snack food, the system may also generate a similar rule for prepared food. In some embodiments, machine learning algorithm may aggregate purchase request rejections/approvals, group purchases, and/or user inputted rules to look for patterns and commonalities to generate/populate new rules and/or modify existing rules. In some embodiments, the machine learning algorithm may populate purchase rules based on histories of other shopping groups. For example, a shopping group may be clustered with other shopping groups based on their purchase history, purchase decision history, member demographics, member location, etc. and a rule from one group may be adopted or suggested to a similar group. In some embodiments, the system may present rules created by a machine learning algorithm to one or more users for verification and only system generated rules that has been verified by group members are automatically enforced.

In some embodiments, the machine learning algorithm for creating and refining purchase rules may be based on one or more of decision tree learning, association rule learning, artificial neural networks, deep learning, inductive logic programming, support vector machines, clustering, Bayesian networks, reinforcement learning, representation learning, similarity and metric learning, sparse dictionary learning, genetic algorithms, rule-based machine learning, and learning classifier systems.

In step 205, the system automatically rejects or automatically approves the purchase request based on the at least one purchase rule and the product characteristics associated with the one or more products in the request. In some embodiments, the system compares the product characteristics retrieved in step 203 with the purchase rules retrieved in step 204 to determine whether each product should be automatically rejected or automatically approved. In some embodiments, the system may be configured to only automatically approve requests and forward requests that are not automatically approved to the group. In some embodiments, the system may be configured to only automatically reject requests and forward requests that are not automatically rejected by the group. In some embodiments, if no rule applies to a specific product, the system may forward the purchase request to one or more other group members to obtain an approval.

In some embodiments, the system may determine confidence levels for system populated rules based on: the number of input sample set, the consistency in the input sample set, the similarity of the input sample set to the rule, the specificity of the rule compared the purchase request etc. The system may generate and/or apply a system populated rule if the confidence level exceeds a threshold. Otherwise, the system may forward the purchase request to the group. In some embodiments, the system may allow users in the group to override the automatic rejection or approval after step 205. If an item is automatically approved by the system or approved by the group, the item may be added to a group basket/shopping list. Members of the group may then go through checkout at the POS system using the group's payment account. In some embodiments, if a purchase request is rejected, the system may further recommend one or more alternative products based on purchase rules associated with the shopping group. For example, if the purchase request exceeds the group's budget, the system may recommend a lower priced item for purchase. In another example, if a high-calorie item is rejected because of a nutrition restriction purchase rules, the system may recommend a similar product that meets the group's nutrition requirement purchase rule. In some embodiments, the system may further use the group's profile to recommend a purchase method (e.g. order online, pickup in store).

In some embodiments, one or more of steps 202-205 may be repeated multiple times for different items before a user proceeds to checkout. In some embodiments, multiple instances of steps 201-205 may be carried out simultaneously on a central computer system for a plurality of users and groups. With the steps described with reference to FIG. 2, the system may learn and enforce purchase rules for a group (e.g. family, social group, organization, company) via a group shopping user interface to facilitate group purchases.

Referring now to FIG. 3, a method for facilitating group retail purchases via electronic user interfaces is shown. In some embodiments, the steps in FIG. 3 may be performed by a processor-based device such as one or more of a user device, a central computer, a server system, and a POS system. In some embodiments, one or more steps in FIG. 3 may be performed by one or more of the first user device 141, the second user device 142, the central computer system 110, and the POS system 120 described with reference to FIG. 1 herein or similar devices.

In step 301, the system receives a purchase request from a member of a shopping group. In some embodiments, a user may generate a purchase request by adding the item to a group virtual shopping basket/shopping list. In some embodiments, the user may select an item from an online shopping user interface to add to a group basket/shopping list. In some embodiments, the user may capture an image (e.g. barcode, label, packaging, etc.) of the item to add an in-store item to the group basket/shopping list. In some embodiments, a purchase request generally refers to a request to purchase one or more items using the group's payment account. In some embodiments, step 301 may comprise step 201 or a similar process.

In some embodiments, after step 301, the system may forward the purchase request to one or more members of the group. In some embodiments, the system may forward the purchase request to only primary members or all members based on the group's setup. In some embodiments, the system may display item information and options to reject or approve the purchase on the group shopping user interface displayed on the user device of one or more other members of the group. In some embodiments, the purchase request may comprise a pop-up notification on a mobile device, an in-app message, an email message, and/or a text message. In step 302, the system receives a purchase decision from another member of the shopping group, the purchase decision comprises a rejection or an approval of the purchase request.

In step 303, the system retrieves product characteristics associated with the one or more products from the product database. In some embodiments, product characteristics may comprise one or more of product price, product category, product description, age restriction, product nutrition information, product material, and product ingredient. In some embodiments, product characteristics may be retrieved from the product database 133 or a similar database.

In step 304, the system compares the purchase decision from step 302 with existing rules in the database associated with the shopping group. In some embodiments, rules associated with the product and/or the group may be retrieved from rules database 135 or a similar database. In some embodiments, the system may determine if one or more existing rules is applicable to the item selected in the purchase request. In some embodiments, the group's purchase decision may be compared with purchase rules associated with the selected item and/or item characteristics (e.g. price, ingredient, age restriction, etc.). In some embodiments, the system applies one or more rules to the purchase request to determine whether the purchase rule results in the same decision as the user inputted decisions. In some embodiments, the system may determine whether the purchase decision conflicts with an existing system populated rule. For example, if a rule specifies a restriction for peanuts containing products, a decision to buy a candy bar with peanuts conflicts with the rule.

In step 305, the system updates the purchase rules based on the comparison in step 304 using machine learning. In some embodiments, if the purchase decision does not match one or more purchase rules in the rules database associated with the shopping group, the system may add a new purchase rule or modify an existing purchase rule associated with the shopping group in the rules database. In some embodiments, the system may remove or adjust the parameters of a conflicting rule. For example, the maximum per-item price limit may be adjusted. In some embodiments, user purchase decisions may be aggregated over time and purchase rules may be generated and/or modified based on the aggregated purchase decisions. In some embodiments, group purchase decisions may be used to adjust the confidence level associated with one or more system generated rules. For example, if a system generated purchase rule comes to the same decision as the user, the confidence level associated with the purchase rule may be increased. In some embodiments, if the decision conflicts with a user-configured rule, the system may notify the customer and suggest an alternate rule. In some embodiments, machine learning algorithm may aggregate item rejections, approvals, and user inputted rules to look for patterns and commonalities to generate/populate new rules and/or modify existing rules. In some embodiments, the machine learning algorithm may populate purchase rules based on histories of other shopping groups. For example, a shopping group may be clustered with other shopping groups based on their purchase history, purchase decision history, member demographics, member location, etc. In some embodiments, the machine learning algorithm for creating and refining purchase rules may be based on one or more of decision tree learning, association rule learning, artificial neural networks, deep learning, inductive logic programming, support vector machines, clustering, Bayesian networks, reinforcement learning, representation learning, similarity and metric learning, sparse dictionary learning, genetic algorithms, rule-based machine learning, and learning classifier systems.

In some embodiments, steps 301-305 may be repeated for a plurality of items over time. With steps 301-305, the system may continuously update and refine rules in the rules database to automatically reject or approve purchase requests for shopping groups based on the user's interaction with the user interface.

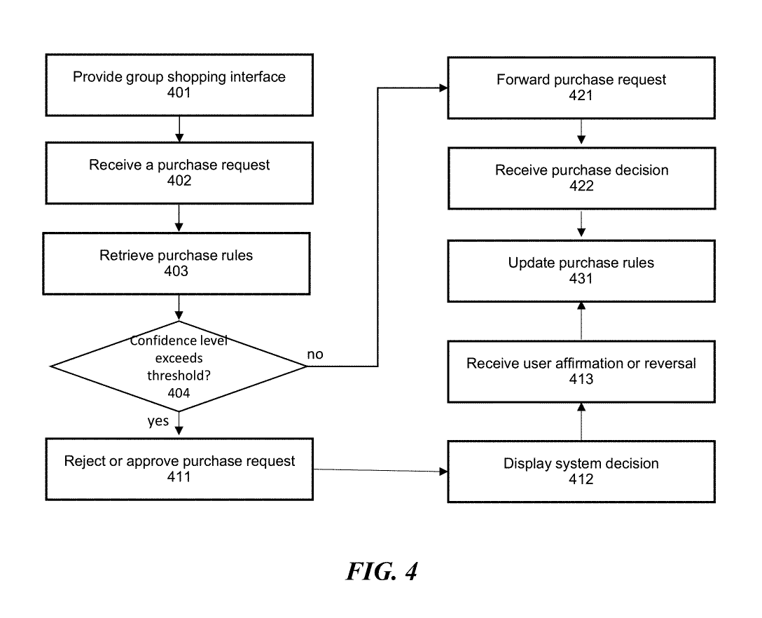

Referring now to FIG. 4, a method of facilitating group retail purchases via electronic user interfaces is shown. In some embodiments, the steps shown in FIG. 4 may be performed by a processor-based device such as one or more of a central computer system, a server, a user device, and a point of sale system. In some embodiments, the steps in FIG. 4 may be performed by one or more of the central computer system 110, the POS system 120, the first user device 141, and the second user device 142 described with reference to FIG. 1 herein or similar devices.

In step 401, the system provides a group shopping user interface to a plurality of user interface devices. The group shopping interface may be configured to facilitate group purchase decisions in shopping groups. In some embodiments, the group shopping user interface may comprise one or more of a software program, a mobile application, a cloud-based application, a VR device application, an AR device application, a web page, a web browser extension, a graphical user interface, and the like. In some embodiments, users may initiate and/or join group shopping sessions through the group shopping user interface. For example, a customer may select one or more users on their contacts list to start a group shopping session. In some embodiments, after a customer initiates a group shopping session, the customer may be provided a session ID to give to others to join the session. In some embodiments, step 401 may comprise step 201 or a similar process.

In step 402, the system receives a purchase request from a member of a shopping group. In some embodiments, a user may create a purchase request by adding the item to a group virtual shopping basket/shopping list. In some embodiments, the user may select an item from an online shopping user interface to add to a group basket/shopping list. In some embodiments, the user may capture an image (e.g. barcode, label, packaging, etc.) of the item to add an in-store item to the group basket/shopping list. In some embodiments, step 402 may comprise step 202, step 301, or a similar process.

In step 403, the system retrieves purchase rules for the purchase request. One or more purchase rules associated with the shopping group of the purchase request may be retrieved from the rules database. A rules database such as rules database 135 may store purchase rules for a plurality of shopping groups. In some embodiments, purchase rules may comprise rules specifying the conditions under which items may or may not be added to a group shopping cart and/or purchased by a shopping group. In some embodiments, the rules database comprises system-populated purchase rules created by a machine learning algorithm based on a group history of the shopping group. In some embodiments, the rules database may comprise user configured purchase rules inputted by one or more members of the shopping group through the group shopping interface. In some embodiments, step 403 may comprise step 204 or a similar process.

In step 404, the system determines whether the confidence level associated with a rule exceeds a threshold. In some embodiments, the system may determine a confidence level for a system-populated rule based on one or more of: the number of input sample set, the consistency in the input sample set, the similarity of the input sample set to the rule, the specificity of the rule compared the purchase request, etc. In some embodiments, user configured rules in the rules may be applied by default, bypassing step 404. In some embodiments, machine-generated rules may be presented to the members of the group for verification. System generated rules that are verified by group members may also bypass step 404 and proceed directly to step 411.

If the confidence level associated with the rule or the group is above a set threshold, in step 411, the system may automatically reject or approve the purchase request based on the purchase rules. In some embodiments, step 411 may comprise step 205 or a similar process. In step 412, the system's automated decision from step 411 is provided to group members, including the user who made the purchase request in step 402. In some embodiments, in step 411, one or more members may have the option to affirm the system automated decision or reverse the decision. In step 413, the system receives user's affirmation or reversal of the system decision. For example, if the system rejects a request to purchase soda, a primary user in the group, seeing the rejection, may override the decision and allow the purchase. In step 431, the system updates the system populated purchase rule and/or the confidence level associated with the purchase rule based on the user's affirmation or reversal in step 413. For example, if the decision is reversed, the system may decrease the confidence level or modify the rule.

If the confidence level associated with the rule or the group is below a set threshold in step 404, in step 421, the system does not make an automatic decision on forwards the purchase request to the group. In some embodiments, the purchase request may be forwarded to one or more members of the group that can authorize purchases (e.g. parents, supervisors, etc.). In some embodiments, the purchase request may be forwarded to all members of the group for voting.

In step 422, the system receives the group's decision to approve or reject the purchase request. In some embodiments, step 422 may comprise step 302 or a similar process. In step 431, the system updates the purchase rules in the rules database based on the group's decision in step 422. In some embodiments, step 431 may comprise steps 304 and 305 or a similar process. In some embodiments, if the purchase decision does not match one or more purchase rules in the rules database associated with the shopping group, the system may add a new purchase rule or modify an existing purchase rule associated with the shopping group in the rules database. In some embodiments, the system may further remove or adjust the parameters of a conflicting rule. In some embodiments, group purchase decisions may be aggregated over time and purchase rules may be generated and/or modified based on the aggregated group history. In some embodiments, group purchase decisions may be used to adjust the confidence level associated with one or more rules. For example, if the rule comes to the same decision as the user, the confidence level may be incrementally increased. In some embodiments, if the decision conflicts with a user-configured rule, the system may notify the customer and suggest an alternate rule.

In some embodiments, steps 401-412 may be repeated for a plurality of items over time. With steps 401-412, the system may continue to update and refine rules in the rules database that can be used to automatically reject or approve purchase requests for shopping groups. With the methods and systems described herein, the system may use machine learning to predict a group's purchase decision using group history and, over time, begin to automatically approve or reject group purchase requests on behalf of the group.

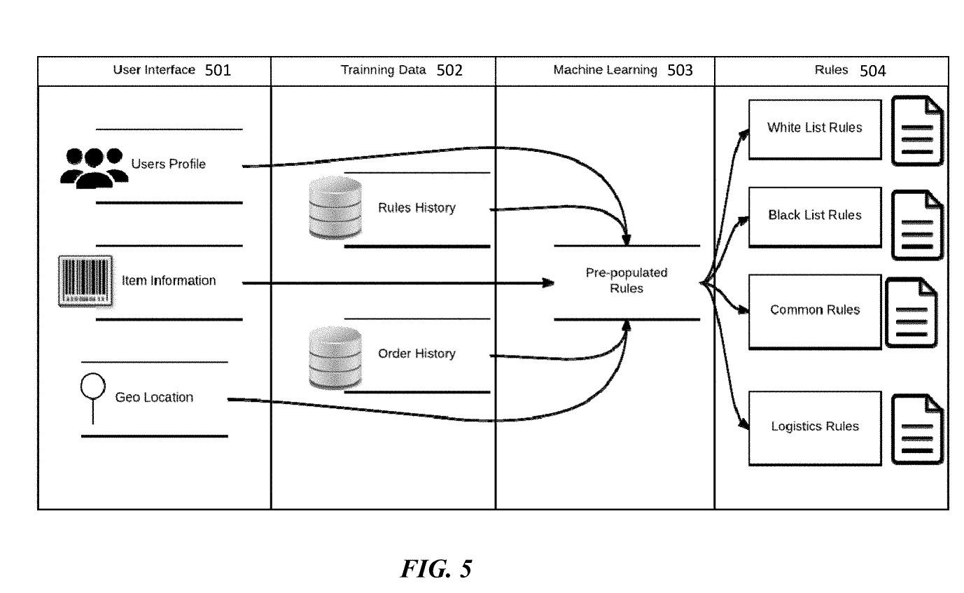

Next referring to FIG. 5, a data flow diagram according to some embodiments is shown. In the user interface layer, users profiles, item information, and user geolocation are collected through the user interface 501. The system also stores training data 502 comprising rules history and order history associated with shopping groups. Data collected through the user interface and the training data are processed through machine learning 503 to generate pre-populated rules. In some embodiments, the rules 504 may comprise whitelist rules, blacklist rules, common rules, and logistics rules. Whitelist rules may comprise items or item characteristics that would be automatically approved by the system. Blacklist rules may comprise items or item characteristics that would be automatically rejected by the system. Common rules may comprise rules corresponding to the group's overall activity such as per-period spending, per-period item purchase count, etc. Logistics rules may correspond to rules related when and where items may be purchased, ordered, pickup, etc. In some embodiments, the logistics rules may be used to calculate cost-efficient logistic routes and cost-saving options for the shopping group. A rule enforcement system may then use the rules to automatically reject or approve purchase requests in shopping groups.

In some embodiments, a system for providing a shared shopping experience through utilizing machine learning across retail ecosystem (e.g. in-store, on the go, and at home) is provided to empower multi-channel and back-end services interactions. In some embodiments, the system allows customers at different locations to interact with the same shopping basket at the same time and share a personalized and cloud-based shopping experience. The system may use natural language processing to determine if the customer needs help and dispatch associates as needed to address the customer's concerns. The system may use a rule engine and machine learning to evaluate and enforce rules for shopping groups' shared baskets. The system may further use logistics engine and machine learning to calculate cost-efficient logistic routes and saving options for a particular shopping group or basket. The system may also include a payment engine for handling dynamic and regular payments for group baskets. The system may further use machine learning predictive models and optimization algorithms to provide real-time recommendations to the customers in-store or online.

In some embodiments, a rules engine may use data sources comprising one or more of rules history, order history, user profiles, item information, user location, and store location. In some embodiments, the rules engine may output one or more of initial rules, evaluate rules metrics, add or modify rules, and utilize self-directed decision-making. In some embodiments, the rules engine may manage, evaluate, and enforce rules for shopping groups sharing a group basket. In some embodiments, a group may be created with an initial set of rules (e.g. items >$200 not allowed, age restricted items need approval . . . etc.). Additional custom rules may be added by the users which are then used as a reference set for the machine learning rules engine. In some embodiments, user profiles may provide information about users in the group such as their age, shipping location, payment capability . . . etc. Metrics for individual rules such as approval rate, approval/denial amount . . . etc. may be calculated by the machine learning according to rule history and order history. Machine-generated rules allow the system to approve/decline an item without user input. Additionally, machine learning may add rules to the existing set of rules or modify an existing rule based on the group's decision history.

In some embodiments, a logistic engine is provided to calculate a route for the retailer's logistics department (e.g. cost reduction vs. price reduction). The inputs of the logistic engine may comprise one or more of group member location, distribution center location, labor cost, preventative maintenance, and supplier information. The outputs of the logistic engine are generally configured to encourage organized operations to increase labor efficiency, asset utilization, inventory accuracy, and cost reduction. In some embodiments, the logistics engine may determine whether to provide group members different options such as pick up at the current store or a nearby store that have more stocks near another group member, etc.

In some embodiments, a payment engine is provided to facilitate payments for a shopping group. In some embodiments, a common payment is set up in the cross-channel wallet as the method of payment for the group. In some embodiments, this payment method may be used by any member of the group on any channel in accordance with the rules that are created by the leader of the group. These rules may comprise one or more of: transaction spending limits, individual spending limits, group sending limit, item restriction based on item type, item restriction based on purchase frequency of buying, and item return restriction. In some embodiments, a machine learning rules engine may monitor and dynamically apply one or more rules for the shopping basket along with the payment engine. In some embodiments, the payment engine may save customers money, reduce the time of maintaining multiple cards, reduce potential money transfer fees from one member to the other, and reduce the retailer cost for processing multiple transaction authorizations.

In some embodiments, a recommendation engine is provided to provide recommendations to group members. In some embodiments, the inputs of the recommendation engine comprise one or more of group members shopping history, group member locations, item information, sales info, etc. In some embodiments, the recommendation may output content based recommendation (CBR), collaborative filtering (CF) neighborhood models, and matrix factorization.

In some embodiments, the systems and methods described herein provide customers a common shopping experience within the retailer's ecosystem (in-store, on-the-go, and at-home) by providing a common shopping basket across the retail ecosystem. The system may further use natural language processing (NLP) and machine learning to help customers to interact with associates.

In some embodiments, a machine learning engine is trained on data available with the retailer to predict future outcome and determine a solution for the company and/ or the customer. This information is passed on to cloud systems to give instructions focused on real-time analyzation and future prediction. In some embodiments, the system may display real-time analytics for customers based on their shopping history.

In some embodiments, the systems and methods described here may provide an enterprise solution to learn on current customer's needs, associate needs, in-store data, and online data to find outcomes in the data. The system may process current trends to predict future trends in-store, on-the-go, or at-home. The outcome data may be used by a virtual assistant system to provide voice assistance to customers and associates with no geographic boundaries and no offline/online difference. In some embodiments, the system trend analysis data may be used to digitalize difference use cases across a retailer ecosystem.

In some embodiments, the system comprises a cloud-based engine, machine learning engine, analytics engine in an application to provide an improved shopping experience to customers. In some embodiments, the systems and methods may be used to enhance Walmart app, Walmart Scan & Go, and similar user interfaces.

In one embodiment, a system for facilitating group retail purchases via electronic user interfaces comprises a network interface configured to communicate with a plurality of user interface devices, a product database storing characteristics of a plurality of products offered for sale, a rules database storing purchase rules for a plurality of shopping groups, and a control circuit coupled to the network interface, the product database, and the rules database. The control circuit being configured to provide a group shopping interface to the plurality of user interface devices via the network interface, the group shopping interface being configured to facilitate group purchase decisions in shopping groups, receive a purchase request from a member of a shopping group, the purchase request comprises a request to purchase one or more products, retrieve product characteristics associated with the one or more products from the product database, retrieve at least one purchase rule from the rules database, wherein the rules database comprises system populated purchase rules generated through a machine learning algorithm based on a group history of the shopping group, and automatically reject or automatically approve the purchase request based on the at least one purchase rule and the product characteristics associated with the one or more products.

In one embodiment, a method for facilitating group retail purchases via electronic user interfaces comprises providing, with a control circuit, a group shopping interface to a plurality of user interface devices via a network interface, the group shopping interface being configured to facilitate group purchase decisions in shopping groups, receiving, at the control circuit, a purchase request from a member of a shopping group, the purchase request comprises a request to purchase one or more products, retrieving product characteristics associated with the one or more products from a product database storing characteristics of a plurality of products offered for sale, retrieving at least one purchase rule from a rules database storing purchase rules for a plurality of shopping groups, wherein the rules database comprises system populated purchase rules generated through a machine learning algorithm based on a group history of the shopping group, and automatically rejecting or automatically approving, by the control circuit, the purchase request based on the at least one purchase rule and the product characteristics associated with the one or more products.

In one embodiment, a system for facilitating group retail purchases via electronic user interfaces. The system comprises a network interface configured to communicate with a plurality of user interface devices, a product database storing characteristics of a plurality of products offered for sale, a rules database storing purchase rules for a plurality of shopping groups, and a control circuit coupled to the network interface, the product database, and the rules database. The control circuit being configured to receive a purchase request from a member of a shopping group, the purchase request comprises a request to purchase one or more products, receive a purchase decision from another member of the shopping group, the purchase decision comprises a rejection or an approval of the purchase request, retrieve product characteristics associated with the one or more products from the product database, compare the purchase decision and products characteristic associated with the purchase request with purchase rules in the rules database associated with the shopping group, and in the event that the purchase decision does not match one or more purchase rules in the rules database associated with the shopping group, add a new purchase rule or modify an existing purchase rule associated with the shopping group in the rules database.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for facilitating group retail purchases via electronic user interfaces, the system comprising:
a network interface configured to communicate with a plurality of user interface devices;
a product database storing characteristics of a plurality of products offered for sale;
a rules database storing purchase rules for a plurality of shopping groups; and
a control circuit coupled to the network interface, the product database, and the rules database, the control circuit being configured to:
provide a group shopping interface to the plurality of user interface devices via the network interface, the group shopping interface being configured to facilitate group purchase decisions in shopping groups;
receive a purchase request from a member of a shopping group, the purchase request comprises a request to purchase one or more products;
retrieve product characteristics associated with the one or more products from the product database;
retrieve at least one purchase rule from the rules database, wherein the rules database comprises system populated purchase rules generated through a machine learning algorithm based on a group history of the shopping group; and
automatically reject or automatically approve the purchase request based on the at least one purchase rule and the product characteristics associated with the one or more products.

2. The system of claim 1, wherein the rules database further comprises user configured purchase rules inputted by one or more members of the shopping group through the group shopping interface.

3. The system of claim 2, wherein the machine learning algorithm is further configured to generate one or more system populated purchase rules based on existing user configured purchase rules.

4. The system of claim 1, wherein the group history comprises past rejections and approvals of purchase requests and/or past group purchases.

5. The system of claim 1, wherein the group history comprises past user overrides of one or more system populated purchase rules.

6. The system of claim 1, wherein the system populated purchase rules are generated further based on histories of other shopping groups.

7. The system of claim 1, wherein the product characteristics comprises one or more of product price, product category, product description, age restriction, product nutrition information, product material, and product ingredient.

8. The system of claim 1, wherein purchase rules in the rules database comprises one or more of maximum per-item price restriction, maximum per-period spending restriction, product unit limit, age restriction, product category restriction, product nutrition restriction, product material restriction, and product ingredient restriction.

9. The system of claim 1, wherein one or more shopping groups comprises at least one secondary member whose purchases through the group shopping interface requires approvals from one or more primary members of the shopping group.

10. The system of claim 1, wherein in the event that the purchase request is rejected, the control circuit is further configured to recommend one or more alternative products based on purchase rules associated with the shopping group.

11. A method for facilitating group retail purchases via electronic user interfaces, the method comprising:
providing, with a control circuit, a group shopping interface to a plurality of user interface devices via a network interface, the group shopping interface being configured to facilitate group purchase decisions in shopping groups;
receiving, at the control circuit, a purchase request from a member of a shopping group, the purchase request comprises a request to purchase one or more products;
retrieving product characteristics associated with the one or more products from a product database storing characteristics of a plurality of products offered for sale;
retrieving at least one purchase rule from a rules database storing purchase rules for a plurality of shopping groups, wherein the rules database comprises system populated purchase rules generated through a machine learning algorithm based on a group history of the shopping group; and
automatically rejecting or automatically approving, by the control circuit, the purchase request based on the at least one purchase rule and the product characteristics associated with the one or more products.

12. The method of claim 11, wherein the rules database further comprises user configured purchase rules inputted by one or more members of the shopping group through the group shopping interface.

13. The method of claim 12, wherein the machine learning algorithm is further configured to generate one or more system populated purchase rules based on existing user configured purchase rules.

14. The method of claim 11, wherein the group history comprises past rejections and approvals of purchase requests and/or past group purchases.

15. The method of claim 11, wherein the group history comprises past user overrides of one or more system populated purchase rules.

16. The method of claim 11, wherein the system populated purchase rules are generated further based on histories of other shopping groups.

17. The method of claim 11, wherein the product characteristics comprises one or more of product price, product category, product description, age restriction, product nutrition information, product material, and product ingredient.

18. The method of claim 11, wherein purchase rules in the rules database comprises one or more of maximum per-item price restriction, maximum per-period spending restriction, product unit limit, age restriction, product category restriction, product nutrition restriction, product material restriction, and product ingredient restriction.

19. The method of claim 11, wherein in the event that the purchase request is rejected, the control circuit is further configured to recommend one or more alternative products based on purchase rules associated with the shopping group.

20. A system for facilitating group retail purchases via electronic user interfaces, the system comprising:
a network interface configured to communicate with a plurality of user interface devices;
a product database storing characteristics of a plurality of products offered for sale;
a rules database storing purchase rules for a plurality of shopping groups; and
a control circuit coupled to the network interface, the product database, and the rules database, the control circuit being configured to:
receive a purchase request from a member of a shopping group, the purchase request comprises a request to purchase one or more products;
receive a purchase decision from another member of the shopping group, the purchase decision comprises a rejection or an approval of the purchase request;
retrieve product characteristics associated with the one or more products from the product database;
compare the purchase decision and products characteristic associated with the purchase request with purchase rules in the rules database associated with the shopping group; and
in the event that the purchase decision does not match one or more purchase rules in the rules database associated with the shopping group, add a new purchase rule or modify an existing purchase rule associated with the shopping group in the rules database.
